(19) United States
(12) Patent Application Publication
(10) Pub. No.: US 2015/0108035 A1
(43) Pub. Date: Apr. 23, 2015

(54) SUBJECT SPECIFIC CALENDAR WITH DAILY CONSUMABLE AND/OR GIFT

(71) Applicant: Annmarie Delforte, Shortsville, NY (US)

(72) Inventor: Annmarie Delforte, Shortsville, NY (US)

(21) Appl. No.: 14/521,768

(22) Filed: Oct. 23, 2014

Related U.S. Application Data
(60) Provisional application No. 61/894,700, filed on Oct. 23, 2013.

(51) Int. Cl. B42D 5/04

(52) U.S. Cl. CPC B42D 5/047
USPC 206/562

(57) ABSTRACT

A calendar/dispenser apparatus comprises a tray and cover. The tray has a plurality of recesses and a sufficient thickness such that a consumable and/or gift may be contained within a respective recess. The cover is arranged above the tray and has a top surface and a bottom surface. A plurality of polygonal die cuts within the cover defines a plurality of doors. Each door is moveable between a normally closed position which conceals the bottom surface of the cover as defined by the door and an opened position which reveals the bottom surface of the cover as defined by the door. The bottom surface of the cover includes a plurality of printed indicia providing health related information with each respective printed indicium printed within an area defined by a respective door. Opening of a respective door permits access to the consumable and/or gift contained with its respective recess.

### This application claims priority to U.S. Provisional Application Ser. No. 61/894,700 filed on Oct. 23, 2013 and is incorporated herein by reference.

### FIELD OF THE INVENTION

The present invention relates to a combination calendar and pill holder/dispenser, and more particularly, to a calendar and pill holder/dispenser which holds a desired consumable product such as vitamins, for example. Specifically, the present invention relates to a pill holder/dispenser of vitamins or other consumable or gift designed generally as an advent-type calendar wherein subject related information is displayed while promoting the daily intake of a vitamin.

### BACKGROUND OF THE INVENTION

Advent calendars which hold a daily piece of candy are known. What is needed is an advent-type calendar for other subject-specific purposes and which include an incentive to use the calendar each day.

### BRIEF SUMMARY OF THE INVENTION

In general, one embodiment the present invention is directed to a pill holder/dispenser of vitamins designed generally as an advent-type calendar wherein a particular subject information is displayed while promoting the daily intake of the vitamin. The subject can be prenatal, toddler, or any other desired age group of child or adult (e.g., seniors).

Preferably, the pill holder/dispenser is arranged to have four rows each having seven columns. This arrangement generally corresponds to each row equating to one week (7 days with each row's respective columns representing one day) with all four rows generally equating to one calendar month. In one embodiment the subject comprises a prenatal calendar. Although generally referred to as 9 months of pregnancy, full term is generally regarded as 40 weeks. Using 40 weeks for full term, this would require ten “monthly” calendars (4 weeks per calendar time 10 calendars equals 40 total weeks). However, an embodiment of the present system generally includes provision of nine “monthly” calendars. Only nine calendars are required as the 40 week start date begins at the start date of the last menstrual cycle prior to becoming pregnant. Ovulation (and likely fertilization) generally occurs two weeks later, with most pregnancy tests confirming pregnancy requiring an additional two weeks following fertilization before being able to quantitate a protein indicating pregnancy. Thus, many pregnant women first become aware of, or are ensured of, their pregnancy only after at least four weeks, thereby obviating the need for one “monthly” calendar.

Accordingly, in one embodiment of the present invention, a calendar/dispenser apparatus comprises a tray and cover. The tray has a plurality of recesses and a sufficient thickness such that a pharmaceutical agent may be contained within a respective recess. The cover is arranged above the tray and has a top surface and a bottom surface. A plurality of polygonal die cuts within the cover defines a plurality of doors. Each door is moveable between a normally closed position which conceals the bottom surface of the cover as defined by the door and an opened position which reveals the bottom surface of the cover as defined by the door. The bottom surface of the cover includes a plurality of printed indicia providing health related information with each respective printed indicium printed within an area defined by a respective door. Opening of a respective door permits access to the pharmaceutical agent contained with its respective recess.

The embodiments of the present invention are well-suited to promote the taking of a daily vitamin while simultaneously engaging the target of the subject with subject related information/activities.

In another embodiment, the subject and vitamins are directed and appropriate for a toddler. The vitamins can take any form (e.g., gummy vitamins) and may alternately be another other consumable or gift/toy or any combination thereof. The written material and images on the calendar are also directed to the subject matter (e.g., toddler growth and health). This of course can be tailored to any desired age group including seniors.

In another embodiment, the indicia and/or pictures on the calendar are directed to a comic series (e.g., SUPERMAN or SPIDERMAN) and/or a card collecting game (e.g., similar to the YUGIO or POKEMON card games) wherein each door comprises a card of the collection and is removable from the calendar (e.g., by clean tear off perforations). A single collection may be one or more months provided by each single monthly calendar, for example. Each card may further include indicia telling part of a story (e.g., as in a comic) that continues with each daily card.

The embodiments of the present invention are well-suited to promote the taking of a daily vitamin (or other consumable or gift) while simultaneously engaging the target of the subject with subject related information/activities.

Additional objects, advantages and novel features of the present invention will be set forth in part in the description which follows, and will in part become apparent to those in the practice of the invention, when considered with the attached figures.

### BRIEF DESCRIPTION OF THE DRAWINGS

The accompanying drawings form a part of this specification and are to be read in conjunction therewith, wherein like reference numerals are employed to indicate like parts in the various views, and wherein:

FIG. 1 is a perspective view of a calendar and pill holder/dispenser according to an embodiment of the present invention;

FIG. 2 is a perspective view of a calendar and pill holder/dispenser according to second embodiment of the present invention;

FIG. 3 is a perspective view of a calendar and pill holder/dispenser tray according to an embodiment of the present invention;

FIG. 3A is a cross-sectional view of the tray and pharmaceutical agent as taken along line 3A-3A of FIG. 3.

FIG. 4 is a perspective view of a second calendar and pill holder/dispenser tray according to an embodiment of the present invention;

FIG. 5 is a perspective view of a third calendar and pill holder/dispenser tray according to an embodiment of the present invention.

### DETAILED DESCRIPTION OF THE INVENTION

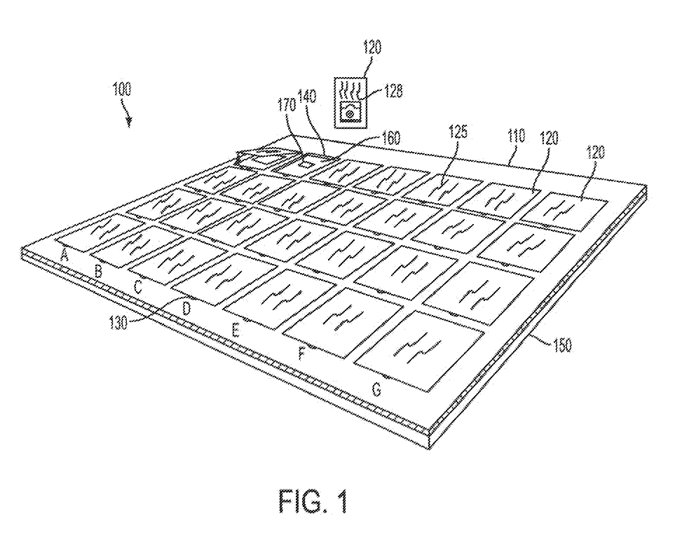

Referring to the drawings in detail, and specifically to FIG. 1, a calendar and pill holder/dispenser 100 is generally comprised of a cover 110 positioned atop a tray 150. Cover 110 includes a plurality of polygonal die cuts each defining a door 120. In a preferred embodiment, the doors are generally constructed as an advent-style calendar, and are more preferably arranged in a grid pattern having four rows of seven columns. In this manner, each row would represent one week with each column representing a specific day of the week. While shown as generally rectangular in shape, the die cuts may be made in any desired size and shape. The die cuts creating a single door are intermittently placed around the circumference defining such door so that the panel constituting door 120 is not completely severed from cover 110 upon manufacture. An additional, optional die cut 130 may be added so as to provide a convenient finger access point for lifting, and if desired removing, the door 120 from cover 110 to create cover opening 140.

The top surface of each door 120 is provided with printed indicia 125. Printed indicia 125 associates its respective door with a respective day so as to enable a user to open doors within the proper sequence. The reverse, or bottom, surface of door 120 includes printed indicia 128. Printed indicia 128 provide relevant health related information to the user or any other information that is relevant to the subject matter of the calendar. For instance, in a preferred embodiment of a prenatal calendar, printed indicia 128 may contain information such as, but not necessarily limited to, fetal development information, maternal health information, an inspirational message, advice on parenting, discount offers, coupons and journal questions. In this example, fetal development information may include pictures, drawings and/or text describing the typical growth progress of a fetus according to the specific day within the gestation period indicated by door 120. Similarly, maternal health information may relate to typical emotional states or hormone levels experienced by expectant mothers at the door-specified time. Each door 120 may be further designed with die cuts so as to be removable from the cover and thereby define a cover opening 140. In this manner, each detached door 120 can be separately added to a journal or scrapbook so that an expectant mother can revisit her pregnancy some later time in the future, perhaps with her child once the child is old enough to understand and appreciate the gift of birth.

In a preferred embodiment, the information provided by printed indicia 128 is arranged such that the leftmost door (A) of each row presents a drawing or photo representing the development stage of the fetus along with a brief description of fetal size and one or two facts about this stage. Moving left to right along a row, the next column (B) provides an inspirational message, factual information regarding this stage of the pregnancy or a fun anecdote about the feelings or concerns experienced by other pregnant women. The third column from the left (C) provides a question designed to cause the expectant mother to reflect upon her pregnancy and upcoming motherhood. Expectant mothers are encouraged to journal these reflections so that these mothers may later read and reminisce upon their pregnancies. The middle column (D) is similar to the second column and again provides an inspirational message, factual information regarding this stage of the pregnancy or a fun anecdote about the feelings or concerns experienced by other pregnant women. The fifth column (E) provides some money saving tips and may further include discounts or coupons for purchasing relevant merchandise (e.g. baby clothes, diapers, cribs and other furniture). The sixth column (F) is similar to the second and fourth columns while the seventh (and last) column (G) re-asks the question of the third column so that the expectant mother can readdress her feelings and reflect upon completing another week in her pregnancy. As can be seen by one skilled in the art, printed indicia 128 may be any desired information and is not specifically limited to the above recitation. The above recitation is merely exemplary and any suitable information or messages are contemplated by the present invention.

Tray 150 is formed to include a plurality of recesses 160. Ideally, the locations of recesses 160 correspond to locations of doors 120 formed on the cover 110. Each recess 160 is adapted to contain one or more pharmaceutical agents 170. Thus, the overall size of the recess is dictated by the volume required to hold a desired one or more pharmaceutical agents. The length and width of the recess may be limited by the physical dimensions of door 120, but the recess depth may be varied to provide the necessary space. It should be understood that the length and width of the recess (and door 120) must be sufficient such that any pharmaceutical agent(s) stored within tray 150 will pass through cover opening 140.

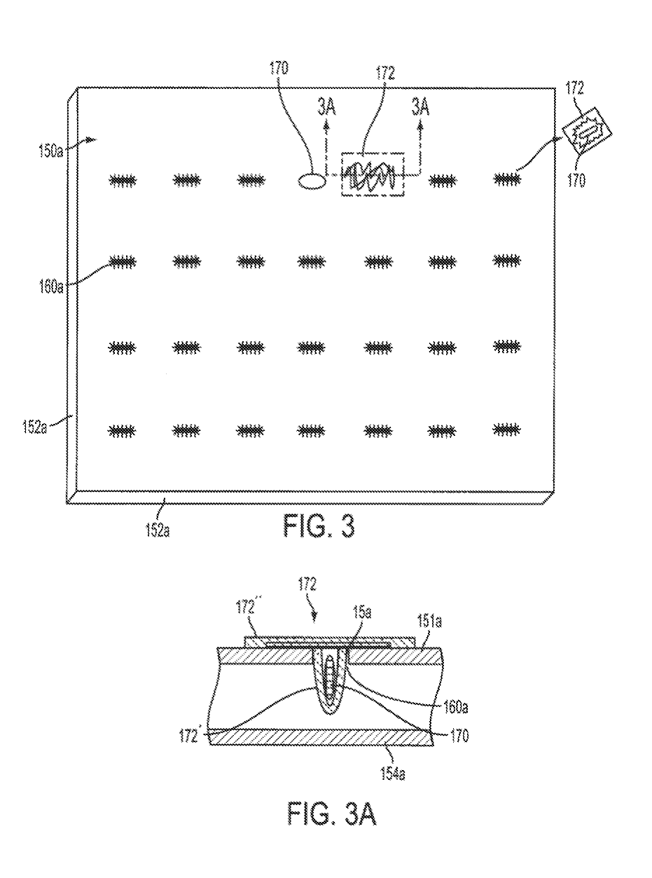

Pharmaceutical agents may be either individual agents packaged within a blister pack or be loose pharmaceuticals having no additional packaging. Preferably, the pharmaceutical agents are solid (pills, capsules, caplets) or semi-solids (chews, gummies, gels). In embodiments for use with loose pharmaceutical agents, tray 150 is fabricated of a suitable plastic material, and more preferably of a plastic material that is gas- and water-tight. For embodiments for storing and dispensing pharmaceutical agents that are packaged within blister packs, tray 150 may be fabricated from cardboard or other suitable card stock materials. Examples of such embodiments will be discussed in more detail below with regard to FIGS. 3-5.

In a preferred embodiment, the pharmaceutical agent is a prenatal vitamin, and more preferably is a prenatal vitamin within a blister pack. Using prenatal vitamins in blister packs enables more efficient loading of the vitamins within the tray while minimizing the potential of contaminating the vitamin during assembly of the holder/dispenser.

As shown in FIG. 1, an example of a first embodiment 100 of the present invention has a cover 110 laminated directly to tray 150. That is, a bottom surface cover 110 and/or a top surface of tray 150 has an adhesive coated thereon such that once sufficient pressure is applied to the cover the adhesive serves to bond the cover and tray together as a single unit. Adhesive material should not be located proximate doors 120 to minimize the possibility that a particular door would not be openable. In the embodiment shown in FIG. 1, one or more of the recesses 160 in tray 150 is filled with the desired pharmaceutical agent(s) 170 (whether loose or within blister packaging) prior to bonding the cover and tray together. Therefore, additional care should be taken to minimize the possibility of applying adhesive to the pharmaceutical agent(s) or any blister packaging that may be present. It is furthermore noted that any desired means may be used to attach cover 110 to tray 150 which may not require the use of an adhesive (e.g., ultrasonic welding).

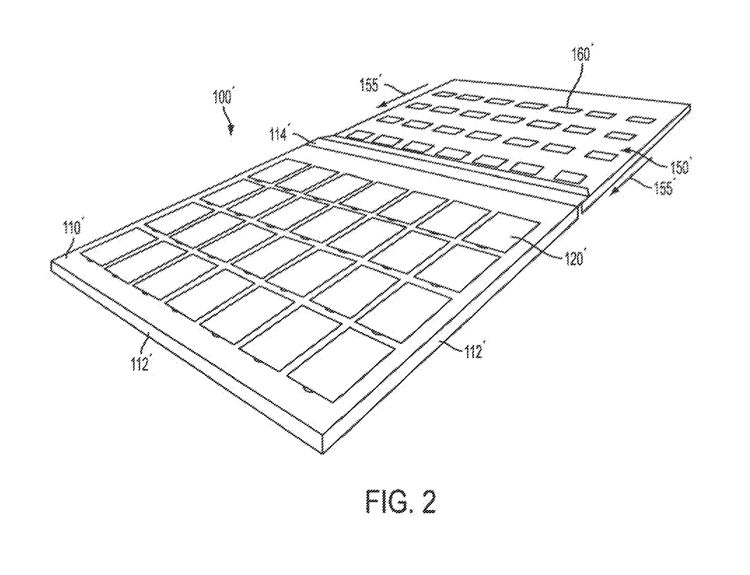

Turning now to FIG. 2, an example of a second embodiment 100′ of a calendar and pill holder/dispenser of the present invention is shown. Calendar and pill holder/dispenser 100′ generally comprises a cover 110′ and tray 150′. Tray 150′ is similar to that described above with regard to tray 150. Cover 110′ further includes a base (not shown) disposed in a plane generally parallel with cover 110′ with the circumferential ends of the cover and base joined by respective sidewalls 112′ thereby forming a cavity. One of sidewalls 112′ is adapted to function as a foldable flap 114′. Foldable flap 114′ is provided along one edge of cover 110′ and is adapted to fold over so as to enclose the cavity formed by the cover, base and sidewalls. Prior to enclosing the cavity with flap 114′, tray 150′ is inserted into the cavity (as indicated generally by arrows 155′) such that each recess 160′ (being prefilled with one or more pharmaceutical agents) corresponds with a respective door 120′. Preferably, sidewalls 112′ and flap 114′ are sized so as to be slightly larger than the thickness of tray 150′ such that the tray fits snuggly within the cavity formed by the cover, base and sidewalls.

FIGS. 3 through 5 illustrate various tray configurations which may be employed as a tray 150 or 150′ within embodiments of the calendar and pill holder/dispenser 100 or 100′, respectively, as described above. Tray 150/150′ may be constructed as a solid plastic unit through any suitable forming process such as thermoforming or injection molding. The plastic tray preferably has a thickness greater than that of a pharmaceutical agent (either loose or within a blister package) to be stored within the recess(es) of the tray. Alternatively, tray 150/150′ may be constructed from cardboard or other suitable card stock. The card stock tray may generally comprise a top panel 151a (see FIG. 3A) with at least one pair of opposing sidewalls 152a. An optional base 154a (see FIG. 3A) may be employed to improve rigidity of the tray or to assist in preventing dislocation of the pharmaceutical agent(s) from its respective recess.

As shown in FIG. 3, tray 150a is configured to have a plurality of voids 160a defined by tray edges 150a′. Voids 160a are proportioned to conform generally to the size and shape of the particular pharmaceutical agent 170 (i.e., prenatal vitamin) to be inserted within the void so that a snug fit between the tray and the pharmaceutical agent holds the pharmaceutical agent in place until being accessed through cover opening 140. The pharmaceutical agent may be inserted into the void without any additional packaging.

Alternatively, as shown in FIG. 3A through an example of a card stock style tray, the pharmaceutical agent may be stored within its own blister packaging 172 such that the agent 170 along the portion of blister enclosing the agent 172′ may be inserted into the void with the remainder of the blister packaging 172″ lying flat along the surface of tray 150a. Again, a snug fit is created within the void 160a through the friction created by the blister package 172′ and tray edge 150a′. Should the pharmaceutical agent be packaged within a blister pack, it is to be understood that the cover door 120/120′ be proportioned such that the individual blister pack be removable from the tray through its respective cover opening.

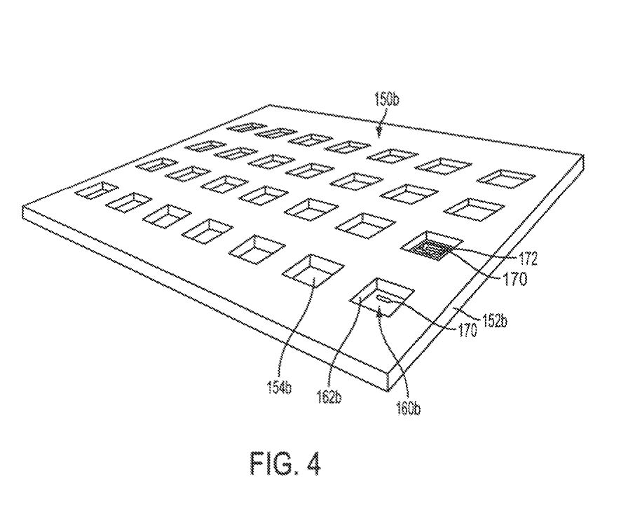

FIG. 4 shows an alternative tray configuration 150b. Tray 150b is configured to have a plurality of wells 160b defined by sidewalls 162b and tray base 154b. Wells 160b are generally proportioned to match the length and width of a door 120/120′ of a cover 110/110′. Wells sidewall depth is determined by the size of the pharmaceutical agent to be stored within the well in that it should be slightly larger than the corresponding dimension of the agent. Tray width 152b is slightly larger than sidewall depth 162b such that tray 150b has a continuous base along its bottom. Stored within wells 160b are free (non-blister packed) pharmaceutical agent(s) 170 and/or a pharmaceutical agent 170 within its blister pack 172. Utilizing a tray 150b with wells 160b allows for placing of multiple agents within a single well thereby allowing, if desired, more than one agent to be dispensed upon opening of a single door.

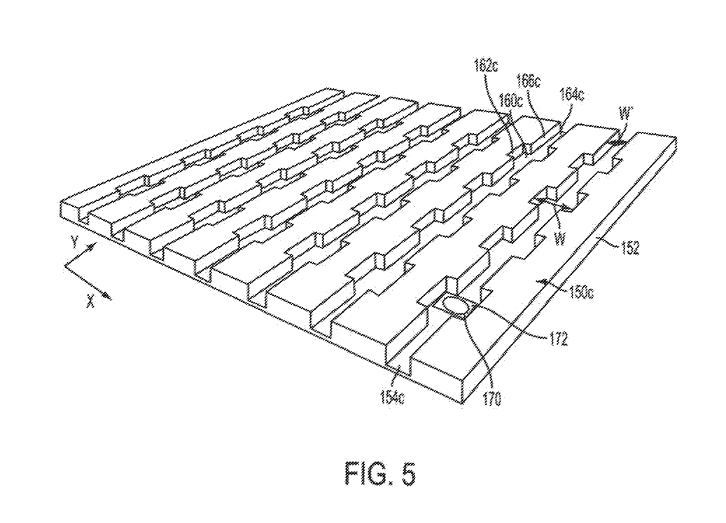

Directing attention to FIG. 5, a third example of a tray 150c is shown. Tray 150c is similar to tray 150b described previously in that tray 150c is configured to have a plurality of wells 160c formed therein; the wells defined by a sidewall 162c and tray base 154c. Well sidewall 162c depth is determined by the size properties of the desired pharmaceutical agent 170 and blister packaging 172 to be store within the well 160c. Well 160c has a width W selected to be slightly wider than the width of blister packaging 172 such that blister packaging 172 fits snuggly within the well. Tray 150c further possesses a channel 164c defined by channel walls 166c and tray base 154c. Each channel 164c runs between and connects adjacent wells 160c along a single axis, for instance along the y-axis as shown and referenced in FIG. 5. Channel sidewalls 166c preferably have a similar sidewall depth as sidewall 162c of well 160c. Channels 164c have a width W′ which is smaller than width W (and the width of blister packaging 172) such that a blister pack stored within a well cannot migrate within the channel. The blister pack is constrained within the well where it can be accessed through cover opening 140 after opening (and if desired removal) of a door 120/120′ as discussed previously.

Although the present invention has been described in considerable detail with reference to certain aspects thereof, other versions are possible as described above. Therefore, the spirit and scope of the appended claims should not be limited to the description of the aspects contained herein.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A calendar/dispenser apparatus comprising:
a) a tray having a plurality of recesses, the tray having a sufficient thickness such that a consumable or gift may be contained within a respective recess;
b) a cover arranged above the tray, the cover having a top surface and a bottom surface; and
c) a plurality of polygonal die cuts within the cover defining a plurality of doors, each door moveable between a normally closed position concealing the bottom surface of the cover as defined by the door and an opened position revealing the bottom surface of the cover as defined by the door,
wherein the bottom surface of the cover includes a plurality of printed indicia providing subject related information, each respective printed indicium printed within an area defined by a respective door,
and wherein opening of a respective door permits access to the consumable or gift contained with the respective recess of the plurality of recesses.

2. The calendar/dispenser apparatus of claim 1 wherein the tray is laminated to the bottom surface of the cover.

3. The calendar/dispenser apparatus of claim 1 wherein the cover further includes sidewalls and a base so as to form a sleeve and wherein the tray is housed within the sleeve.

4. The calendar/dispenser apparatus of claim 1 wherein the subject is health related information and said consumable is a vitamin.

5. The calendar/dispenser apparatus of claim 1 wherein the plurality of recesses and the plurality of doors are arranged in a grid pattern.

6. The calendar/dispenser apparatus of claim 5 wherein the grid pattern has four rows of seven columns.

7. The calendar/dispenser apparatus of claim 1 wherein each door is removable from the cover.

8. The calendar/dispenser apparatus of claim 1 wherein each door includes printed indicia on the top surface for associating the door with a unique day.

9. The calendar/dispenser apparatus of claim 1 wherein the recess is a void such that the consumable or gift fits snuggly within the void so as not to become dislodged prior to being accessed through the open door.

10. The calendar/dispenser apparatus of claim 1 wherein the recess is a well.

11. The calendar/dispenser apparatus of claim 1 wherein the recess is a well wherein adjacent wells are interconnected by a channel along a single common axis.
